(19) United States
(12) Patent Application Publication
(10) Pub. No.: US 2026/0049626 A1
(43) Pub. Date: Feb. 19, 2026

(54) TARP CLIP

(71) Applicant: Steven P. Bayless, Port Huron, MI (US)

(72) Inventor: Steven P. Bayless, Port Huron, MI (US)

(21) Appl. No.: 19/298,447

(22) Filed: Aug. 13, 2025

Related U.S. Application Data
(60) Provisional application No. 63/682,432, filed on Aug. 13, 2024.

(51) Int. Cl. F16B 2/22

(52) U.S. Cl. CPC F16B 2/22

(57) ABSTRACT

A gripping device for securing a tarp can include a first member and a second member. The first member can include a ring formed from a single helical piece of metal having overlapping ends with hooks, and the second member can include a ring receiver with a circumferential channel. Alternatively, the first member can include a clamp with intersecting handles forming an opening, and the second member can include a clamp receiver. The gripping device can accommodate tarps of various thicknesses and materials, provide a secure grip resistant to wind and movement, and can allow for easy installment and adjustment. A method can include positioning the second member on one side of the tarp, the first member on the side opposite the second member and coupling the first member and the second together to create a compression joint that can hold the tarp in place.

### CROSS-REFERENCE TO RELATED APPLICATIONS

This application claims the benefit of U.S. Provisional Application No. 63/682,432, filed on Aug. 13, 2024. The entire disclosure of the above application is incorporated herein by reference.

### FIELD

The present technology relates to a fastening device for securing a tarp and, more particularly, to a fastening device including a ring and a ring receiver that couple the tarp therebetween.

### INTRODUCTION

This section provides background information related to the present disclosure which is not necessarily prior art.

Securing a tarp and other flexible covers can present a challenge across various industries, including construction, agriculture, and outdoor events. Ways to secure a tarp and other flexible covers can often prove inadequate, cumbersome, and unreliable under demanding conditions, such rain, wind, or adverse weather conditions. Various approaches can be used, including the use of rope, one or more bungee cords, and one or more weights, yet each has its own drawbacks and limitations. Tarp securing can be time-consuming and relying on pre-made apertures or grommets in the tarp can limit anchor points to predetermined perimeter locations.

Material damage can occur to the tarp in use, which can be dependent on how well the tarp is secured and in what manner. Concentrated stress points can be created by ropes and bungee cords, which can result in tearing of the tarp, particularly under high wind conditions or when the tarp becomes brittle due to cold temperatures. Although the risk of tearing can be militated when a weight is used to hold a tarp, the effectiveness can be diminished in strong winds, and additional challenges are presented in transporting and positioning the weights, especially for larger tarps.

Adjustability and ease of use offered by certain tarp clips can present unsatisfactory solutions. Certain tarp clips are not designed to accommodate varying tarp thicknesses or material types, and a secure grip often cannot be maintained, resulting in slippage or detachment. This lack of versatility and reliability can necessitate frequent adjustments and re-applications, leading to an inefficient and labor-intensive securing process.

Accordingly, there is a need for a more effective, versatile, and reliable device and method for securing a tarp that is both practical and effective in a wide range of conditions that would accommodate a tarp of various thicknesses and materials without requiring pre-made apertures, provide a secure grip that can resist wind and movement, and be easy to install and adjust.

### SUMMARY

In concordance with the instant disclosure, a more effective, versatile, and reliable method for securing a tarp that can accommodate tarps of various thicknesses and materials without requiring pre-made holes, provide a secure grip that resists wind and movement, and be easy to install and adjust, has surprisingly been discovered. The present technology includes articles of manufacture, systems, and processes that relate to the secure fastening of a tarp, including the use of a gripping device that can promote stability and adjustability under diverse environmental conditions.

In certain embodiments, a gripping device for a tarp can include a first member and a second member. The first member can be configured to be positioned on one side of the tarp. The second member can be configured to be positioned on an opposite side of the tarp from the first member. The first member and the second member can be configured to couple together with the tarp disposed therebetween.

In certain embodiments, a method for securing a tarp is provided. The method can include providing a gripping device, as described herein. The first member can be positioned on one side of the tarp. The second member can be positioned on an opposite side of the tarp from the first member. The first member and the second member can be coupled with the tarp disposed therebetween. The first member and the second member can secure the tarp in place, thereby providing a secure and reliable method of attachment.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective exploded view of a gripping device for a tarp, according to an embodiment of the present disclosure;

FIG. 2 is a right-side top perspective view of a first member of the gripping device for a tarp, according to the embodiment shown in FIG. 1;

FIG. 3 is a right-side top perspective assembled view of the gripping device for a tarp, according to the embodiment shown in FIG. 1;

FIG. 4 is a top plan view of the first member of the gripping device for a tarp, according to the embodiment shown in FIG. 1;

FIG. 5 is a right-side elevational view of the first member of the gripping device for a tarp, according to the embodiment shown in FIG. 1;

FIG. 6 is a top perspective view of a second member of the gripping device for a tarp, according to the embodiment shown in FIG. 1;

FIG. 7 is a right-side elevational view of the second member of the gripping device for a tarp, according to the embodiment shown in FIG. 1;

FIG. 8 is a top plan view of the second member of the gripping device for a tarp, according to the embodiment shown in FIG. 1;

FIG. 9 is a top perspective exploded view of a gripping device for a tarp, according to another embodiment of the present disclosure;

FIG. 10 is a top perspective assembled view of the gripping device for a tarp, according to the embodiment shown in FIG. 9;

FIG. 11 is top plan view of the gripping device securing a portion of a tarp, according to the embodiment shown in FIG. 9;

FIG. 12 is bottom plan view of the gripping device securing the portion of the tarp, according to the embodiment shown in FIG. 9;

FIG. 13 is a top perspective view of a gripping device for a tarp, according to yet another embodiment of the present disclosure;

FIG. 14 is a top perspective view of a gripping device for a tarp, according to still another embodiment of the present disclosure;

FIG. 15 is a top plan assembled view of a gripping device for a tarp, according to a further embodiment of the present disclosure;

FIG. 16 is a top plan view of the gripping device securing a portion of a tarp, according to the embodiment shown in FIG. 15; and

FIG. 17 is a flowchart illustrating a method of securing a tarp, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves upon existing tarp securing methods by providing a secure, versatile, and easy-to-use solution for fastening tarps without the need for pre-made holes or grommets, ensuring a snug fit that accommodates various tarp thicknesses and materials while militating against the tarp from slipping or tearing under stress and allowing for quick adjustments and reapplications, significantly reducing labor and enhancing efficiency in securing tarps across a wide range of environmental conditions.

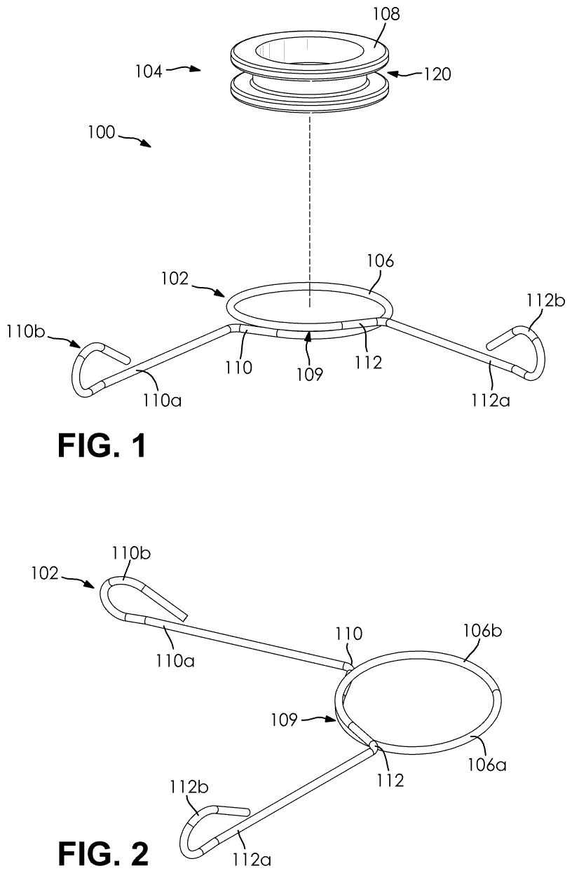

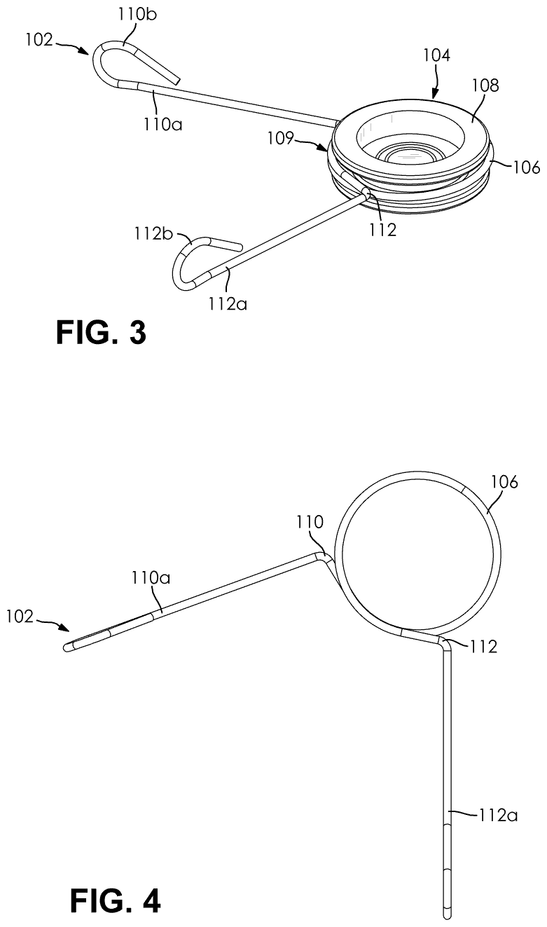

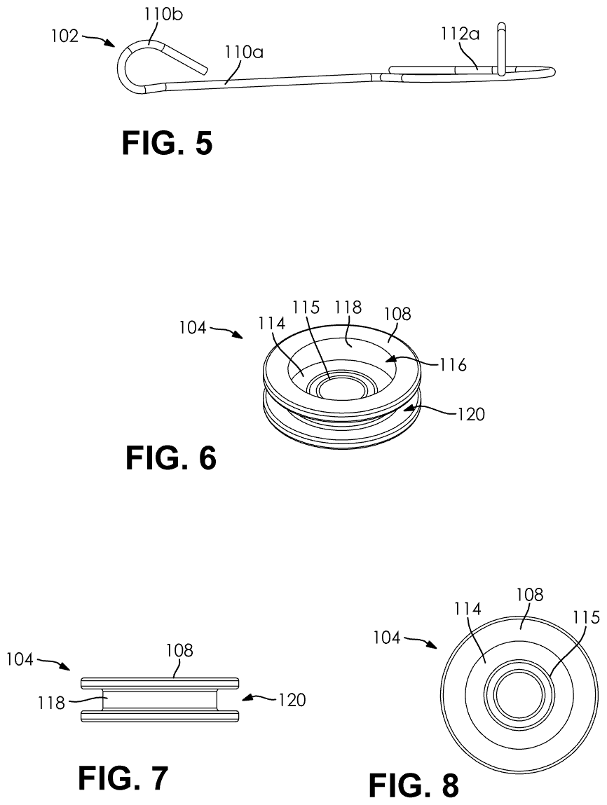

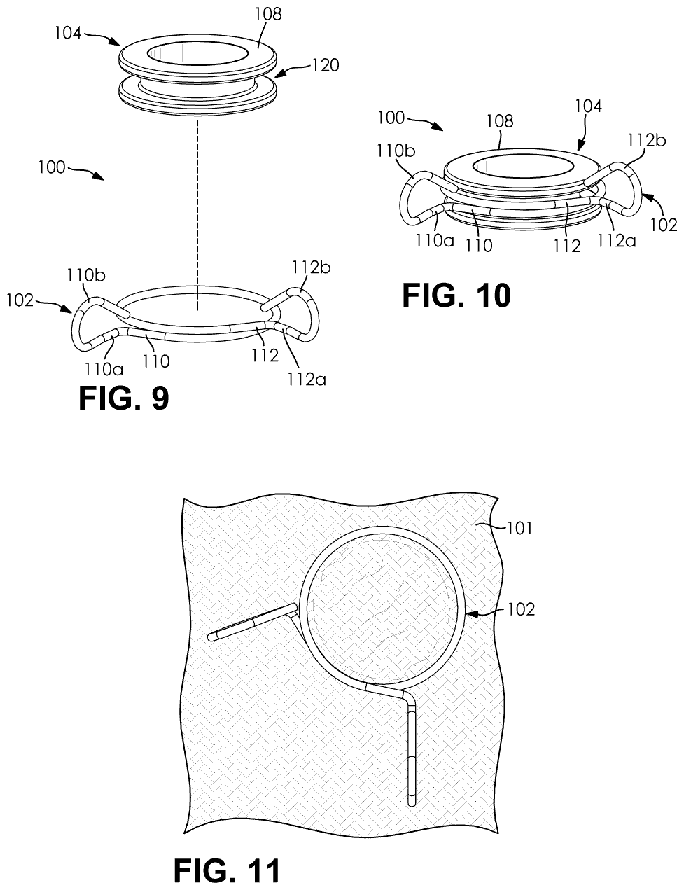

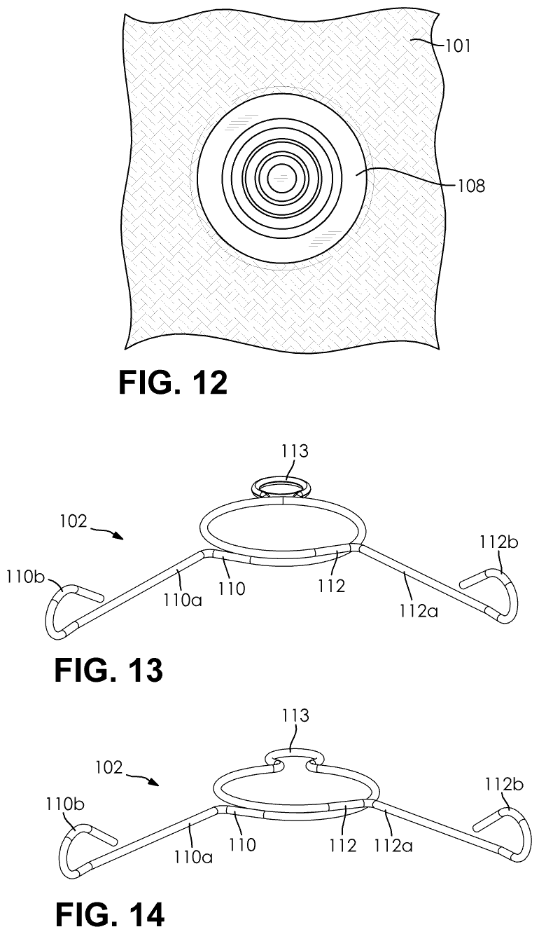

The present invention relates to a gripping device 100, 200 for a tarp 101 designed to securely hold the tarp 101 in place and a method 300 of securing a tarp 101, as shown generally in the accompanying FIGS. 1-17.

The present disclosure provides a gripping device 100 for securing a tarp 101, shown generally in FIGS. 1-16. The gripping device 100 militates against the need for a pre-formed hole or grommet in the tarp 101, which can otherwise weaken the tarp material and limit the available securing points. The gripping device 100 can include a first member 102 and a second member 104. The first member 102 and the second member 104 can couple together with a portion of the tarp 101 disposed therebetween, thereby forming a secure, non-destructive attachment point.

In certain embodiments, and as shown in FIGS. 1-5, 9-11, and 13-14, the first member 102 can be positioned on one side of the tarp 101. The first member 102 can include a substantially ring-like structure 106 (referred to herein as ring 106). The first member 102 can be formed from a single helical piece of material, which imparts structural integrity and can enable reliable fastening of the tarp 101. In certain embodiments, the ring 106 of the first member 102 can be formed from two separate pieces of material, including a first ring segment 106a and a second ring segment 106b. The first ring segment 106a and the second ring segment 106b can be welded or otherwise coupled at a single junction. This two-piece construction can offer advantages in manufacturing and assembly while maintaining the mechanical performance and functional characteristics of the gripping device 100. The welded junction formed between these components can provide structural integrity comparable to a single-piece design while potentially offering cost advantages during manufacturing. The two-piece construction can preserve the operational characteristics of the gripping device 100, when the ring 106 of the first member 102 is coupled with the second member 104 and the tarp 101 is securely disposed therebetween, ensuring that the fundamental gripping mechanism remains consistent regardless of the construction method employed.

In certain embodiments, the ring 106 can undergo elastic circumferential deformation. This elastic deformation can enable the first member 102 to flex under applied load, securely gripping and retaining the tarp 101, and then return to its original shape once the load is released. The ring 106 can include a first end 110 and a second end 112 disposed proximate to each other, with the second end 112 overlapping the first end 110 to define a compressed area 109 within the ring 106. This overlapping configuration can facilitate a spring-like response that can contribute to the compression-based gripping mechanism.

The ring-shaped geometry of the first member 102 can allow it to encircle and engage the second member 104, securely retaining the tarp 101 between. The circular or curved cross-sectional profile of the ring 106 can promote distribution of clamping forces along the perimeter of the engagement area, thereby providing consistent grip strength regardless of the orientation or placement of the gripping device 100 on the portion of the tarp 101. The force distribution can help mitigate stress concentrations and minimize tearing or damage to the tarp 101 during use. In this way, the first member 102 can be configured in a similar fashion to a spring clip. The ring 106 can hence be forced to elastically expand to a diameter greater than a diameter of the second member 104. The force can be removed to allow the ring 106 to return to a diameter equal to or less than the second member 104 when the tarp 101 is positioned between the first member 102 and the second member 104 and the first member 102 is positioned about the second member 104.

In certain embodiments, the first end 110 and the second end 112 can be positioned less than halfway around the perimeter of the first member 102 from one another. With reference to FIGS. 1-5, 9-10, and 13-14, a portion of the first end 110 and the second end 112 can overlap to form the ring-like structure of the first member 102. This positioning can create a compressed area 109 within the first member 102 that can serve as the foundation for the gripping force. Locating the first and second ends 110, 112 less than halfway around the perimeter can promote expansion of the ring 106 diameter when compression forces are applied, enabling the first member 102 to accommodate the second member 104 during coupling while maintaining sufficient overlap to generate the necessary compression to securely retain the tarp 101. The helical structure of the first member 102 can provide the mechanical advantage required for the first member 102 to function both as a coupling mechanism and as a secure gripping element. In certain embodiments, the first member 102 can be substantially horseshoe-shaped, including an open portion where the first member 102 and the second member 104 would otherwise overlap. The first member 102 can therefore be configured in a similar fashion to a C-clip or circlip. One having ordinary skill in the art can select a suitable configuration for the first member 102 within the scope of the present disclosure.

The first end 110 of the first member 102 can include a first projection 110a, and the second end 112 can include a second projection 112a. Compression of the first projection 110a relative to the second projection 112a can increase the diameter of the ring 106, allowing the first member 102 to be positioned over the second member 104. When the first projection 110a is in an uncompressed state relative to the second projection 112a, the ring 106 diameter can be dimensioned to closely fit the second member 104, thereby creating a secure gripping action that can secure the tarp 101. The projections 110a, 112a can be in an open or a closed configuration to provide varying functional characteristics and user interaction options.

In certain embodiments, and with reference to FIGS. 1-3, 5, 9-10, 13-14, the projections 110a and 112a can include a first hook 110b and a second hook 112b, respectively, The first hook 110b and the second hook 112b can provide a vantage point for user manipulation and can accommodate various attachment methods, such as receiving a bungee or other rope through the first hook 110b and the second hook 112b to further secure the tarp 101. The first hook 110b and the second hook 112b can facilitate the decoupling process, as users can hold onto the first hook 110b and the second hook 112b and pull the first member 102 away from the second member 104 to de-couple and unfasten the gripping device 100 from the tarp 101. In certain embodiments, the first hook 110b and the second hook 112b can be separate components from the ring 106 of the first member 102, configured for subsequent coupling to the respective first ring segment 106a and second ring segment 106b of the first member 102, thereby forming the ring 106 assembly. This modular approach can enhance customization and manufacturing efficiency by enabling the fabrication of individual components separately prior to assembly.

In certain embodiments, the first projection 110a can include a first loop (not shown) and the second projection 112a can include a second loop (not shown), thereby creating enclosed structures that can provide secure gripping points for user manipulation of the gripping device 100. The first loop and the second loop can offer enhanced gripping surfaces that militate against slippage during handling and additionally serve as attachment points for supplementary securing mechanisms. The first loop and the second loop can facilitate coupling of the first member 102 to the second member 104, and alternatively provide a means for the user to disengage the gripping device 100 by grasping the first and second loops and pulling the first member 102 away from the second member 104 to decouple and unfasten the gripping device 100 from the tarp 101.

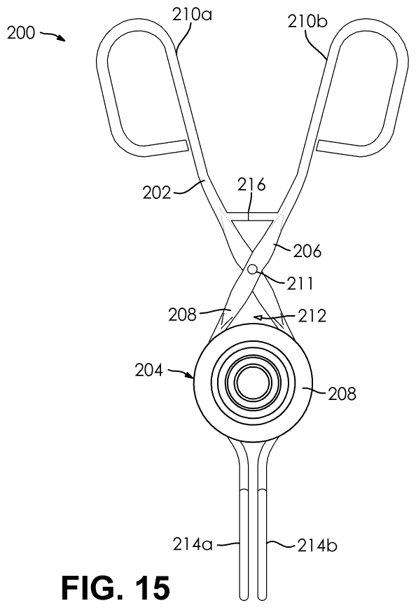

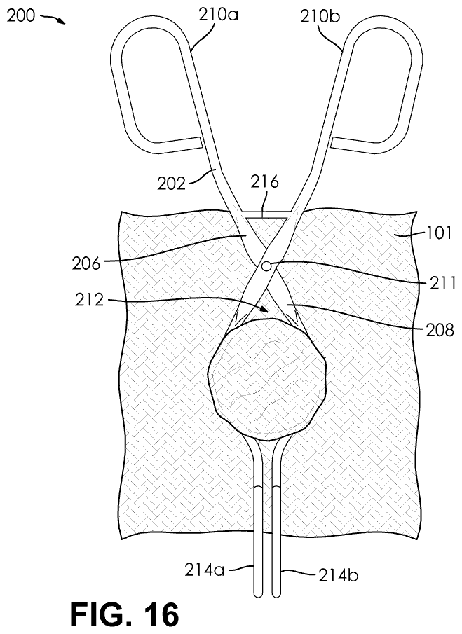

In certain embodiments, and with reference to FIGS. 13 and 14, the ring 106 can include a looped portion 113 having a substantially circular or teardrop-shape. The looped portion 113 can receive and retain a rope, cord, bungee cord, or other elongate flexible securing member. The shape and size of the looped portion 113 can facilitate the attachment of the first member 102 to a fixed structure, such as a stake, pole, hook, or another object, by allowing the securing member to pass through the looped portion 113 and be tied, hooked, or otherwise fastened. The looped portion 113 can provide a robust and reliable point of connection, thereby enabling the gripping device 100 to maintain tension and resist detachment during use. In certain embodiments, the looped portion 113 can be disposed at various locations along the perimeter of the ring 106, allowing the point of attachment to be selected based on the desired orientation or intended direction of force. One having ordinary skill in the art can select a suitable location for the looped portion 113.

The gripping action of the gripping device 100 can result from the relative movement of the projections 112a, 112b, where compression of the first projection 110a relative toward the second projection 112a can increase the diameter of the ring 106. This radial expansion can facilitate the coupling process by allowing the first member 102 to be positioned around the second member 104 during installation. When a user applies compressive force to bring the projections 112a, 112b closer together, the helical structure of the ring 106 responds by expanding its overall diameter, creating clearance for the second member 104 to pass through or be received within a circumference of the ring 106. This functionality can be enabled by the placement of the projections 110a and 112a at the overlapping ends of the helical ring 106 structure of the first member 102, where the applied compression force is mechanically translated into radial expansion of the ring 106.

The uncompressed state of the projections 110a, 112a can define an operational diameter of the ring 106. When the first projection 110a is uncompressed relative to the second projection 112a, the ring 106 diameter can be dimensioned to fit within the second member 104, thereby creating a secure gripping interface. The dimensional relationship can ensure that, in the uncompressed state, the ring 106 naturally seats within a circumferential channel of the second member 104. The interference fit between the uncompressed ring 106 and the channel dimensions of the second member 104 can produce a frictional engagement that can secure the tarp 101 between the first member 102 and the second member 104.

In certain embodiments, the first member 102 can include a material having flexibility and resilience to accommodate the mechanical deformation required for the compression-based coupling mechanism of the gripping device 100. In operation, the first member 102 can exhibit controlled flexibility that can allow the first member 102 to respond to compression forces applied to the first member 102 while maintaining structural integrity and returning the first member 102 to an uncompressed configuration when the force is released. The material of the first member 102 should be capable of withstanding the torquing forces that can occur when the first projection 110a is compressed relative to the second projection 112a, as this compression can translate into radial expansion of the ring diameter through the mechanical response of the helical structure. Suitable materials for the first member 102 can include materials such as stainless steel, titanium, aluminum, brass, or other appropriate metal alloys, each offering a balance of strength, flexibility, and environmental durability. Alternatively, high-performance polymers and composite materials may be employed, including fiber-reinforced nylon, polyether ether ketone (PEEK), acetal (POM), or thermoplastic elastomers (TPEs). The resilient nature of the selected materials can ensure that the ring 106 can repeatedly undergo the compression and expansion cycles necessary for coupling and decoupling operations without experiencing material fatigue or permanent deformation that would compromise the effectiveness or dimensional accuracy of the first member 102 of the gripping device 100 for proper coupling with the second member 104. One having ordinary skill in the art can select a suitable material for the first member 102 within the scope of the present disclosure.

In certain embodiments, the first member 102 can be treated or coated with one or more surface treatments, such as anodizing, powder coating, electroplating, passivation, or polymeric coatings. For metal components, anodizing (particularly for aluminum), passivation (commonly for stainless steel), or electroplating with materials like zinc, nickel, or chrome can provide improved protection against oxidation and corrosion. For polymeric or composite components, surface treatments such as UV stabilizers, flame retardant coatings, or elastomeric overcoatings can improve longevity under harsh environmental exposure. One having ordinary skill in the art can select suitable materials and treatments within the scope of the present disclosure.

In certain embodiments, and with reference to FIGS. 1, 3, and 6-10, the second member 104 can serve as a receiving component of the gripping device 100, cooperating with the first member 102 to form a secure gripping mechanism for the tarp 101. The second member 104 can be positioned on a side of the tarp 101 opposite the first member 102, allowing the gripping device 100 to effectively sandwich the tarp 101 between the first member 102 and the second member 104. This arrangement can generate the clamping force necessary to secure the tarp 101.

In certain embodiments, as shown in FIGS. 1, 3, and 6-10, the second member 104 can include a ring receiver 108 configured to be received by the ring 106 of the first member 102. The ring receiver 108 can be substantially circular in shape and can include a base 114 circumscribed by a sidewall 118, together forming a central opening 116. A circumferential channel 120 can extend around both the base 114 and sidewall 118, the channel 120 being sized and shaped to receive and retain both the tarp 101 and the ring 106 of the first member 102, thereby securing the tarp 101. The channel 120 can be dimensioned to accommodate the tarp 101 sandwiched between the first member 102 and the second member 104, ensuring a firm and stable grip. Additionally, the ring receiver 108 can include multiple channels designed to receive multiple layers of tarp material, enhancing the versatility of the gripping device 100 across various tarp thicknesses and configurations.

The ring receiver 108 can include a material to provide a balance of flexibility and durability. In certain embodiments, the ring receiver 108 can be made from elastomeric materials such as rubber, which offer excellent pliability and resilience. Alternatively, the ring receiver 108 can be manufactured from plastics or other resilient, pliable materials capable of providing the necessary flexibility for the compression and gripping mechanism to operate effectively. The material can allow for tailored levels of flexibility and durability to meet diverse application demands, ensuring that the gripping device 100 can securely accommodate various tarp materials and thicknesses while maintaining reliable performance.

The sidewall 118 of the circumferential channel 120 can include a textured surface to enhance grip on the tarp 101 when the first member 102 and second member 104 are coupled together with the tarp 101 disposed therebetween. The textured surface can create an additional contact point that can mitigate slippage and ensure secure retention of the tarp 101. By providing multiple points of engagement between the tarp 101 and the channel 120, the textured surface of the sidewall 118 can help distribute gripping forces across the tarp material, thereby improving the overall stability. One having ordinary skill in the art can select a suitable textured surface within the scope of the present disclosure.

The base 114 of the ring receiver 108 can include one or more raised concentric circles 115 that can serve as an additional gripping feature to assist the user during coupling of the ring receiver 108 with the ring 106 of the first member 102. The raised concentric circles 115 can enhance tactile feedback and provide improved user control, making it easier to apply the necessary force to press the ring receiver 108 through the ring 106 during installation. The base 114 can be flush against the surface of the tarp 101, while the central opening 116 can allow the user to insert and push the ring receiver 108 through the ring 106, thereby facilitating the coupling process in a stable and ergonomic manner.

As shown in FIGS. 15 and 16, another embodiment of the gripping device 200 can provide an alternative securing mechanism that operates through a compression joint system rather than the ring 106 and ring receiver 108 configuration. In this embodiment, the first member 202 can include a clamp 206 having a first handle 210a and a second handle 210b, while the second member 204 can include a clamp receiver 208 that works in conjunction with the clamp 206 to secure the tarp 101 material. The clamp 206 can also function as a pair of tongs adapted to receive the clamp receiver 208 for holding a tarp 101 therebetween, providing users with a familiar gripping mechanism similar to conventional hand tools.

The handle 210 configuration can be designed to optimize user control and operational efficiency. Each of the first handle 210a and the second handle 210b can be configured to intersect and form an opening 212 adjacent the intersection 211, with the opening 212 configured to receive the clamp receiver 208 creating a compression joint when the first member 202 and second member 204 are coupled together with the tarp 101 disposed therebetween. This intersection design can allow the tarp 101 to be sandwiched between the clamp 206 and the clamp receiver 208 in the opening 212, effectively securing the tarp 101 material through controlled compression forces.

The handles 210 can be designed with enhanced ergonomic features to improve user experience and operational effectiveness and can incorporate various comfort and functionality enhancements to accommodate different user needs and application requirements. The first handle 210a and the second handle 210b can be coated with a soft, non-slip material to provide better grip and reduce hand fatigue during prolonged use. Additionally, the first handle 210a and second handle 210b can include finger grooves to further aid in handling and provide more secure grip points for users. The handles 210 can also be configured to be extended or retracted relative to each other to suit different hand sizes or to provide different leverage points, which can be particularly useful in applications requiring precise control over the clamping force.

The clamp receiver 208 can serve as the receiving element that interfaces with the clamp mechanism to create the securing action. The clamp receiver 208 can be the same as the ring receiver 108, having similar features and functionality as described for the ring-based system, allowing for manufacturing consistency and interchangeable components between different embodiments of the device. The clamp receiver 208 can be configured to be disposed through the opening 212 formed by the intersection of the handles 210a and 210b, where it can create the compression joint that holds the tarp 101 securely in place.

The clamp 206 can include securing features to enhance its functionality and versatility. As shown in FIGS. 15-16, the gripping device 200 can include a first hook 214a and a second hook 214b disposed opposite the handles 210a and 210b respectively, which can be configured to receive a bungee or other rope through the loops to further secure the tarp 101. The hooks 214a, 214b can provide additional anchor points and can be designed with adjustable angles or lengths to accommodate various sizes and types of ropes or bungees, enhancing the adaptability to different tarp sizes and tension requirements. The hooks 214a, 214b can be circular in shape and can be pressed together to form a unified anchor point where securing lines or bungee cords can pass through, providing an effective anchor point to hold the clamp 206 and tarp 101 in place. This configuration can provide additional security to the tarp 101 and hold the gripping device 200 in place, with the hooks 214a, 214b capable of latching onto an edge of the tarp 101 to further support the gripping device 200.

The clamp 206 can also incorporate a locking mechanism 216 configured to lock the clamp 206 in a position when the clamp receiver 208 is disposed in the opening 212 and the first member 202 and second member 204 are coupled together with the tarp 101 disposed therebetween. The locking mechanism 216 can include a serrated edges or teeth, a quick-release lever, a ratchet system, and a magnetic lock, each offering different levels of security and case of use depending on the user's needs. The locking mechanism 216 can also allow the user to easily unlock the locking mechanism 216 to remove the gripping device 200.

The first member 202 and the second member 204 can work together through a coordinated coupling mechanism that can create secure tarp 101 retention through compression and friction-based gripping action. The operational principle can involve positioning the second member 204 underneath the tarp 101 and the first member 202 above the tarp 101, with the first member 202 and the second member 204 configured to couple together with the tarp 101 disposed therebetween. This sandwich configuration can allow the gripping device 200 to capture and hold the tarp 101 material between the two members of the gripping device 200, creating the securing action without requiring pre-made holes or grommets in the tarp 101 material.

In the ring-based embodiment, the operational mechanism can function through a compression and expansion system where the ring 106 of the first member 102 can be manipulated to accommodate the ring receiver 108 of the second member 104. The first end 110 can include a first projection 110a and the second end 112 can include a second projection 112a, and compression of the first projection 110a relative to the second projection 112a can increase the diameter of the ring 106, allowing the first member 102 to be positioned about the second member 104. During operation, the user can compress the projections 110a and 112a to expand the ring 106 diameter, position the ring receiver 108 through the expanded ring 106 opening with the tarp 101 material in between, and then release the compression to allow the ring 106 to contract and fit within the channel 120 of the ring receiver 108. The channel 120 can be configured to tightly hold both the tarp 101 and the ring 106, effectively securing the tarp 101 between the first member 102 and the second member 104 through a friction fit between the tarp 101 and the channel 120 of the ring receiver 108.

The clamp-based embodiment can operate through a different but equally effective compression joint mechanism. The first handle 210a and the second handle 210b can be configured to intersect and form an opening 212 adjacent the intersection 211, with the opening 212 configured to receive the clamp receiver 208 creating a compression joint when the first member 202 and second member 204 are coupled together with the tarp 101 disposed therebetween. During operation, the user can open the clamp 206 by manipulating the handles 210a and 210b to expose the opening 212, position the tarp 101 between the clamp 206 and the clamp receiver 208, insert the clamp receiver 208 through the opening 212, and then release the handles 210a and 210b to allow the compression joint to secure the tarp 101 in place. The locking mechanism 216 can be engaged to prevent the clamp 206 from reopening, maintaining the desired tension and position of the tarp 101 material.

Both operational modes can provide additional securing capabilities through supplementary attachment points. The projections 110a and 112a (including hooks 110b and 112b) disposed on the first member 102 and the hooks 214a, 214b disposed opposite the handles 210a and 210b respectively of the first member 202 can be configured to receive a bungee or other rope through the hooks or loops to further secure the tarp 101, providing additional anchor points that can enhance the overall securing effectiveness. This dual-action approach can accommodate various tarp 101 materials and thicknesses while maintaining consistent performance across different environmental conditions, with the friction fit and compression mechanisms working together to militate against any slippage of the tarp from the tarp gripping device even under the stress of construction equipment, debris, and harsh weather conditions.

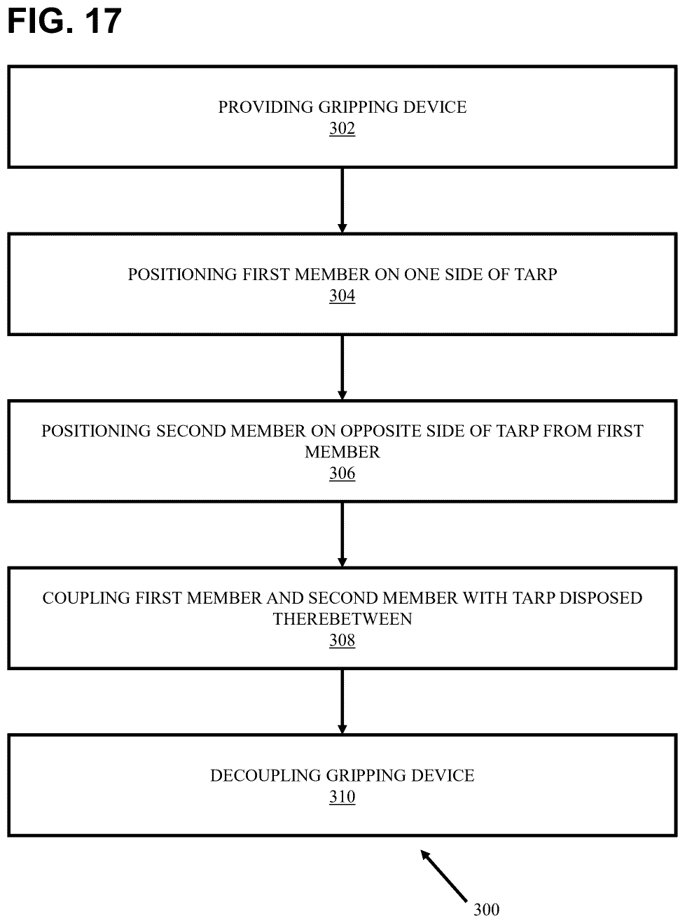

The present disclosure provides a method 300 for securing a tarp 101, shown generally in FIG. 17. The method 300 can include a step 302 of providing a gripping device 100, 200, as described herein. In a step 304, the method 300 can include positioning the first member 102, 202 on one side of the tarp 101. The method 300 can include a step 306 of positioning the second member 104, 204 on the opposite side of the tarp 101 from the first member 102, 202. In a step 308, the method 300 can include coupling the first member 102, 202 and the second member 104, 204 with the tarp 101 disposed therebetween using the compression joint created by positioning the second member 104, 204 underneath the tarp 101 and the first member 102, 202 above the tarp 101. The coupling can include compressing the first projection 110a toward the second projection 112a. This compression can cause the ring 106 to elastically deform and expand its diameter, allowing it to pass over and seat around the second member 104, 204. Once the compression force is released, the ring 106 can contract back toward its original diameter, and the projections 110a, 112a can return to the relaxed state, thereby securely engaging the channel 120 of the second member 104, 204. In step 310, the method 300 can include decoupling the gripping device 100, 200. Decoupling can include applying a compression force to the first and second projections 110a, 112a, thereby expanding the diameter of the ring 106 to release it from the channel 120 of the second member 104, 204. Once the ring 106 is expanded, the first member 102, 202 can be separated from the second member 104, 204, allowing the tarp 101 to be removed. This decoupling step can be performed by gripping designated features such as hooks or loops on the projections 110a, 112a to facilitate safe and controlled disengagement of the first member 102, 202 and second member 104, 204 without damaging the tarp 101.

Advantageously, the gripping device 100, 200 can provide a secure, versatile, and easy-to-use solution for fastening tarps 101 without the need for pre-made holes or grommets. The gripping device 100, 200 can ensure a snug fit that accommodates various tarp 101 thicknesses and materials. The gripping device 100, 200 can not only militate against the tarp 101 from slipping or tearing under stress but can also allow for quick adjustments and reapplications, significantly reducing labor and enhancing efficiency in securing tarps 101 across a wide range of environmental conditions.

### EXAMPLES

Example embodiments of the present technology are provided with reference to the several figures enclosed herewith.

### Example 1: Application of Gripping Device 100

The gripping device 100 can be used to secure a polyethylene tarp during a camping trip. The user can select the gripping device 100 and the first member 102 can be placed above the tarp 101. The ring receiver 108, acting as the second member 104, can then be positioned underneath the tarp 101, opposite the ring 106. The user may align the channel 120 on the ring receiver 108 with the ring 106 and press them together, sandwiching the tarp 101 in between. The user can use the concentric circles 115 in the base 114 as the gripping feature to push the ring receiver 108 and tarp 101 through the ring 106, whereby the tarp 101 is disposed therebetween the ring receiver 108 and the ring 106. Advantageously, the friction fit can militate against any slippage of the tarp 101 from the gripping device 100 even under the stress of construction equipment, debris, and harsh weather.

### Example 2: Application of Gripping Device 200

In using the gripping device 200, the user can take the clamp 206, equipped with the handle 210 designed for easy gripping, and open it by pushing the first handle 210a toward the second handle 210b. This action can expose the opening 212 at the intersection 211, allowing the user to place the tarp 101 between the clamp 206 and the clamp receiver 208. The clamp receiver 208 can be disposed through the opening 212 with the tarp 101 and the clamp 206 can securely hold the clamp receiver 208 and the tarp 101 within the opening 212. Once the tarp 101 is positioned, the user can release the handle 210, allowing the opening 212 to close and to return to the original position, thereby clamping the tarp 101 securely within the opening 212 through a compression joint formed by the clamp 206 and the clamp receiver 208, as shown in FIGS. 15-16. The user can utilize the first hook 210b and the second hook 210b located opposite the handle 210. By attaching a bungee cord or rope through these hooks, the user can further anchor the tarp 101, ensuring it stays in place. The locking mechanism 216 included in the clamp 206 can be engaged to militate the clamp 206 from opening, thus maintaining the desired tension and position of the tarp 101.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A gripping device for a tarp, comprising:
a first member configured to be positioned on one side of the tarp; and
a second member configured to be positioned on an opposite side of the tarp from the first member;
wherein the first member and the second member are configured to couple together with the tarp disposed therebetween.

2. The gripping device of claim 1, wherein:
the first member includes a ring formed from a single helical piece having a first end and a second end, the first end and the second end are disposed less than halfway around a perimeter of the ring from each other; and
the second member includes a ring receiver having a circumferential channel.

3. The gripping device of claim 2, wherein the first end includes a first projection;
the second end includes a second projection, compression of the first projection relative to the second projection increases a diameter of the ring allowing the first member to be positioned about the second member, where when the first projection is uncompressed relative to the second projection, the diameter of the ring is dimensioned to fit within the circumferential channel of the ring receiver.

4. The gripping device of claim 3, wherein the first projection includes a first loop and the second projection includes a second loop.

5. The gripping device of claim 2, wherein the ring is formed of two pieces of metal including a first ring and a second ring configured to be coupled together and welded together at a single junction.

6. The gripping device of claim 2, wherein a sidewall of the circumferential channel of the ring receiver includes a textured surface to enhance grip on the tarp when the first member and the second member are coupled together with the tarp disposed therebetween.

7. The gripping device of claim 2, wherein a base of the ring receiver includes concentric circles that are raised relative to the base that form an additional gripping means when coupling the first member and the second member.

8. The gripping device of claim 2, wherein the ring receiver includes an elastomeric material.

9. The gripping device of claim 2, wherein the ring receiver includes multiple channels for receiving multiple layers of the tarp.

10. The gripping device of claim 1, wherein
the first member includes a ring formed from a single helical piece having a first end and a second end, the first end and the second end are disposed less than halfway around a perimeter of the ring from each other,
the second member includes a ring receiver having a circumferential channel,
the first end includes a first projection,
the second end includes a second projection, compression of the first projection relative to the second projection increases a diameter of the ring allowing the first member to be positioned about the second member, where when the first projection is uncompressed relative to the second projection, the diameter of the ring is dimensioned to fit within the circumferential channel of the ring receiver,
the first projection includes a first loop and the second projection includes a second loop,
the ring is formed of two pieces of metal including a first ring and a second ring configured to be coupled together and welded together at a single junction,
a sidewall of the circumferential channel of the ring receiver includes a textured surface to enhance grip on the tarp when the first member and the second member are coupled together with the tarp disposed therebetween,
a base of the ring receiver includes concentric circles that are raised relative to the base that form an additional gripping means when coupling the first member and the second member, and
the ring receiver includes multiple channels for receiving multiple layers of the tarp.

11. The gripping device of claim 1, wherein:
the first member includes a clamp having a first handle and a second handle; and
the second member includes a clamp receiver.

12. The gripping device of claim 11, wherein the first handle and the second handle are configured to intersect and form an opening adjacent the intersection, the opening configured to receive the clamp receiver creating a compression joint when the first member and the second member are coupled together with the tarp disposed therebetween.

13. The gripping device of claim 12, wherein the first handle and the second handle are configured to be extended and retracted relative to each other.

14. The gripping device of claim 13, further including a first loop disposed opposite the first handle and a second loop disposed opposite the second handle.

15. The gripping device of claim 14, further including a locking mechanism configured to lock the clamp in a position when the clamp receiver is disposed in the opening and the first member and the second member are coupled together with the tarp disposed therebetween.

16. A tarp including a gripping device installed thereon, comprising:
a first member positioned on one side of the tarp; and
a second member positioned on an opposite side of the tarp from the first member;
wherein the first member and the second member are coupled together with the tarp disposed therebetween.

17. A method of securing a tarp, comprising:
providing a gripping device having a first member and a second member;
positioning the first member on one side of the tarp;
positioning the second member on an opposite side of the tarp from the first member; and
coupling the first member and the second member together with the tarp disposed therebetween.

18. The method of claim 17, wherein the first member comprises a ring and the second member comprises a ring receiver.

19. The method of claim 18, wherein the first member comprises a clamp and the second member comprises a clamp receiver.

20. The method of claim 18, wherein coupling the first member and the second member together with the tarp disposed therebetween includes creating a compression joint between the first member and the second member.
